(19) United States
(12) Patent Application Publication
(10) Pub. No.: US 2021/0332274 A1
(43) Pub. Date: Oct. 28, 2021

(54) ADHESIVE COMPOSITION AND FOAMABLE ADHESIVE SHEET

(71) Applicant: DAI NIPPON PRINTING CO., LTD., Tokyo-to (JP)

(72) Inventors: Kentaro HOSHI, Tokyo-to (JP); Shinya SHIMADA, Tokyo-to (JP)

(73) Assignee: DAI NIPPON PRINTING CO., LTD., Tokyo-to (JP)

(21) Appl. No.: 17/277,934

(22) PCT Filed: Sep. 26, 2019
(86) PCT No.: PCT/JP2019/037820

§ 371 Date: Jun. 10, 2021

(30) Foreign Application Priority Data
Sep. 26, 2018 (JP) 2018-180197
Sep. 20, 2019 (JP) 2019-171654

(51) Int. Cl. C09J 163/04; C09J 133/00; C09J 5/08; C09J 7/35; C09J 11/08

(52) U.S. Cl. CPC C09J 163/04; C09J 133/00; C09J 11/08; C09J 7/35; C09J 5/08

(57) ABSTRACT

An adhesive composition including an epoxy resin, an acrylic resin compatibilized with the epoxy resin, a curing agent, and a foaming agent, wherein, as the epoxy resin, the adhesive composition includes a first epoxy resin with a softening temperature of 50° C. or more and an epoxy equivalent of 5000 g/eq or less, and a second epoxy resin with a softening temperature higher than the first epoxy resin and a weight-average molecular weight of 20,000 or more, and a weight-average molecular weight of the acrylic resin is 50,000 or more.

### TECHNICAL FIELD

The present disclosure relates to an adhesive composition and a foaming adhesive sheet.

### BACKGROUND ART

An adhesive that adheres members to each other is used in various fields, and a lot of methods for adhering thereof has been known. For example, Patent Literature 1 discloses a method for attaching a rubber grip to the shaft of a golf club wherein, after winding a double-sided adhesive tape or a pressure-sensitive adhesive tape onto the grip part of the shaft, a high volatile solvent such as thinner is applied to the tape surface and the inner portion of the shaft insertion hole provided on the rubber grip, the grip part is inserted into the shaft insertion hole, and left to stand for a while until the solvent is volatilized. Also, Patent Literature 2 discloses a method for adhering a CFRP pipe and a metal part by an one-pack type epoxy adhesive.

Patent Literature 3 discloses an adhesive sheet including an expandable adhesive layer containing an epoxy resin including a polyfunctional epoxy resin, a phenol resin as a curing agent, an imidazole-based compound as a curing catalyst and a temperature-sensitive foaming agent, and a releasing agent is applied to at least a surface of the expandable adhesive layer. Also, Patent Literature 4 discloses an adhesive comprising an acrylic polymer, an epoxy resin, a thermoplastic resin such as a phenoxy resin and a polyvinyl butyral resin, and an epoxy resin curing agent. Incidentally, Patent Literature 4 discloses that the adhesive is in a form of a sheet (adhesive sheet), and that the adhesive includes a foaming agent.

### CITATION LIST

### Patent Literatures

Patent Literature 1: Japanese Patent Application Laid-Open (JP-A) No. 2007-222445

Patent Literature 2: JP-A No. 2016-221784

Patent Literature 3: Japanese Patent No. 6220100 specification

Patent Literature 4: JP-A No. 2017-203114

### SUMMARY OF DISCLOSURE

### Technical Problem

Patent Literatures 3 and 4 disclose an adhesive sheet (foaming adhesive sheet) including a foaming agent. As a method for using a forming adhesive sheet, for example, a method wherein members are adhered to each other by inserting the foaming adhesive sheet into the clearance between the members, and then, forming and curing the foaming adhesive sheet, has been known. In such a foaming adhesive sheet, a blocking resistance in pre-foamed condition, and an adhesiveness and a crack resistance in foamed and cured condition are desired to be preferable.

The present disclosure has been made in view of the above circumstances, and a main object thereof is to provide an adhesive composition capable of obtaining a foaming adhesive sheet with good blocking resistance, adhesiveness, and crack resistance.

### Solution to Problem

The present disclosure provides an adhesive composition comprising an epoxy resin, an acrylic resin compatibilized with the epoxy resin, a curing agent, and a foaming agent, wherein, as the epoxy resin, the adhesive composition includes a first epoxy resin with a softening temperature of 50° C. or more and an epoxy equivalent of 5000 g/eq or less, and a second epoxy resin with a softening temperature higher than the first epoxy resin and a weight-average molecular weight of 20,000 or more, and a weight-average molecular weight of the acrylic resin is 50,000 or more.

The present disclosure also provides a foaming adhesive sheet comprising at least an adhesive layer, wherein the adhesive layer includes an epoxy resin, an acrylic resin compatibilized with the epoxy resin, a curing agent, and a foaming agent, as the epoxy resin, the adhesive layer includes a first epoxy resin with a softening temperature of 50° C. or more and an epoxy equivalent of 5000 g/eq or less, and a second epoxy resin with a softening temperature higher than the first epoxy resin and a weight-average molecular weight of 20,000 or more, and a weight-average molecular weight of the acrylic resin is 50,000 or more.

### Advantageous Effects of Disclosure

The adhesive composition in the present disclosure exhibits an effect that a foaming adhesive sheet with good blocking resistance, adhesiveness, and crack resistance may be obtained.

### BRIEF DESCRIPTION OF DRAWINGS

FIG. 1 is a schematic cross-sectional view illustrating an example of a foaming adhesive sheet in the present disclosure.

FIG. 2 is a schematic cross-sectional view illustrating another example of a foaming adhesive sheet in the present disclosure.

FIG. 3 is a schematic perspective view illustrating another example of a foaming adhesive sheet in the present disclosure.

FIG. 4 is a schematic perspective view illustrating another example of a foaming adhesive sheet in the present disclosure.

FIGS. 5A and 5B are schematic cross-sectional views illustrating an example of a method for producing a product in the present disclosure.

FIG. 6 is a schematic cross-sectional view explaining a testing method for an adhesiveness.

FIG. 7 is the result of a dynamic viscoelasticity measurement to the acrylic resin in Example 1.

### DESCRIPTION OF EMBODIMENTS

An adhesive composition and a foaming adhesive sheet in the present disclosure will be hereinafter described in detail.

A. Adhesive Composition

The adhesive composition in the present disclosure comprises an epoxy resin, an acrylic resin compatibilized with the epoxy resin, a curing agent, and a foaming agent, wherein, as the epoxy resin, the adhesive composition includes a first epoxy resin with a softening temperature of 50° C. or more and an epoxy equivalent of 5000 g/eq or less, and a second epoxy resin with a softening temperature higher than the first epoxy resin and a weight-average molecular weight of 20,000 or more, and a weight-average molecular weight of the acrylic resin is 50,000 or more.

According to the present disclosure, an adhesive composition capable of obtaining a foaming adhesive sheet with good blocking resistance, adhesiveness, and crack resistance may be obtained by using a first epoxy resin, a second epoxy resin, and an acrylic resin in a combination.

When attempting only an improvement in adhesiveness, for example, it is effective to use an epoxy resin with a lower molecular weight (low epoxy equivalent) than an epoxy resin with a high molecular weight (high epoxy equivalent). However, when the epoxy resin with a lower molecular weight (low epoxy equivalent) is used, the epoxy resins with a lower molecular weight (low epoxy equivalent) are assimilated with each other when, for example, the foaming adhesive sheet is rolled up into a roll, and the blocking easily occurs.

In contrast to this, in the present disclosure, a first epoxy resin with a relatively low softening temperature (relatively high crystallinity) and a low molecular weight (low epoxy equivalent) is used. When the temperature is higher than the softening temperature, the first epoxy resin is rapidly melted and turned into a liquid with a low viscosity. Therefore, it is easy to improve the adhesiveness. Meanwhile, since the first epoxy resin is relatively high in crystallinity, the blocking may be suppressed from occurring, compared to an epoxy resin with relatively low crystallinity or an epoxy resin with no crystallinity. However, when only the first epoxy resin is used, there is a possibility that the blocking suppressing effect is not sufficient, or that the pressure-sensitive adhesiveness (tack property) of the adhesive layer is too high. Therefore, in the present disclosure, a second epoxy resin with relatively high softening temperature (with relatively low crystallinity) and high weight-average molecular weight is further used. Thereby, the blocking suppressing effect may be improved, and the pressure-sensitive adhesiveness (tack property) of the adhesive layer may be kept low. Meanwhile, when the above described first epoxy resin and second epoxy resin are used as the epoxy resin, a new problem arises that the toughness of the adhesive layer is low so that crack resistance is low. In the present disclosure, such new problem is dealt by further using an acrylic resin compatible with the epoxy resin so as to improve the blocking resistance and the adhesiveness while improving the crack resistance. Also, when the acrylic resin and the first epoxy resin are used, and the second epoxy resin is not used, for example, not only the adhesive composition is hard and brittle, but also the diffusion of the first epoxy resin is high, although the adhesiveness is preferable. Therefore, not only the crack resistance is deteriorated, but also the blocking is likely to occur. Also, when the acrylic resin and the second epoxy resin are used, and the first epoxy resin is not used, for example, preferable adhesiveness is not likely to be obtained.

Also, the adhesive composition in the present disclosure is preferably used for producing an adhesive layer of a foaming adhesive sheet. In this case, the foaming adhesive sheet has the following advantages. For example, Patent Literature 1 discloses a method for attaching a rubber grip to a golf club shaft wherein, after winding a double-sided adhesive tape or a pressure-sensitive adhesive tape onto the grip part of the shaft, a high volatile solvent such as thinner is applied to the tape surface and the inner portion of the shaft insertion hole provided on the rubber grip, the grip part is inserted into the shaft insertion hole, and left to stand for a while until the solvent is volatilized. However, the method requires some waiting time for the solvent to be volatilized. In contrast to this, since the adhesive sheet of the foaming adhesive sheet basically includes no solvent, there is an advantage that the working efficiency may be improved.

Also, Patent Literature 2 discloses, for example, a method for adhering a CFRP pipe and a metal part by a one-pack type epoxy adhesive. However, when the one-pack type epoxy adhesive is used, the following tasks may arise; wiping the adhesive protruding from a seam, and protecting a part that should not be in contact with the adhesive with a curing tape. In contrast to this, although the adhesive sheet of the foaming adhesive sheet slightly expands while being formed and cured, there is an advantage that the handling ability thereof is high, compared to a liquid based adhesive.

1. Epoxy Resin

The adhesive composition in the present disclosure comprises, as an epoxy resin, a first epoxy resin and a second epoxy resin. Incidentally, the epoxy resin in the present disclosure is a compound including at least one or more epoxy group or glycidyl group, and cured by causing a crosslinking polymerization reaction by being used in combination with a curing agent. The epoxy resin also includes a monomer including at least one or more epoxy group or glycidyl group.

(1) First Epoxy Resin

The first epoxy resin has a softening temperature of 50° C. or more, and an epoxy equivalent of 5000 g/eq or less. The first epoxy resin has a relatively low softening temperature (relatively high crystallinity) as compared with the second epoxy resin to be described later. Since the first epoxy resin has relatively high crystallinity and low molecular weight, it is easy to improve the adhesiveness and the blocking resistance. Also, since the first epoxy resin has a low molecular weight, a crosslinking density may be increased so that an adhesive layer having good mechanical strength, chemical resistance, and curability may be obtained. Also, it is preferable that the first epoxy resin is a solid epoxy resin at room temperature (23° C.)

The softening temperature of the first epoxy resin is usually 50° C. or more, may be 55° C. or more, and may be 60° C. or more. Meanwhile, the softening temperature of the first epoxy resin is, for example, 150° C. or less. The softening temperature may be measured by a ring and ball method according to JIS K 7234.

The epoxy equivalent of the first epoxy resin is, for example, 5000 g/eq or less, may be 3000 g/eq or less, may be 1000 g/eq or less, and may be 600 g/eq or less. Meanwhile, the epoxy equivalent of the first epoxy resin is, for example, 90 g/eq or more, may be 100 g/eq or more, and may be 110 g/eq or more. The epoxy equivalent may be measured by a method according to JIS K 7236, and is a number of grams of a resin including an epoxy group of 1 gram equivalent.

The first epoxy resin may be a monofunctional epoxy resin, may be a bifunctional epoxy resin, may be a trifunctional epoxy resin, and may be a polyfunctional epoxy resin with four or more functional groups.

Also, the weight-average molecular weight (Mw) of the first epoxy resin is usually lower than the weight-average molecular weight (Mw) of the second epoxy resin to be described later. Mw of the first epoxy resin is, for example 6,000 or less, may be 4,000 or less, and may be 3,000 or less. Meanwhile, Mw of first epoxy resin is, for example, 400 or more. Mw is a value in terms of polystyrene when measured with a gel permeation chromatography (GPC).

The melt viscosity at 150° C. of the first epoxy resin is, for example, 0.005 Pa·s or more, may be 0.015 Pa·s or more, may be 0.03 Pa·s or more, may be 0.05 Pa·s or more, and may be 0.1 Pa·s or more. When the melt viscosity is too low, preferable foaming property may not be obtained. Also, when the melt viscosity of the first epoxy resin is too low (when the crystallinity of the first epoxy resin is too high), the pressure-sensitive adhesiveness (tack property) of the adhesive layer to be obtained may be high. The reason therefor is presumed that, when the melt viscosity of the first epoxy resin is too low (when the crystallinity of first epoxy resin is too high), the crystallinity thereof greatly decreases when it is compatibilized with the second epoxy resin or the acrylic resin so that Tg of the adhesive composition as a whole is decreased. Meanwhile, the melt viscosity at 150° C. of the first epoxy resin is, for example, 10 Pa·s or less, may be 5 Pa·s or less, and may be 2 Pa·s or less. When the melt viscosity is too high, the uniformity of the adhesive layer to be obtained may be decreased. The melt viscosity may be determined by measuring with a Brookfield type single cylinder rotary viscosimeter and a thermos cell for heating a solution, according to JIS K 6862.

Next, a configuration of the first epoxy resin will be described. Examples of the first epoxy resin may include an aromatic epoxy resin, an aliphatic epoxy resin, an alicyclic epoxy resin, and a heterocyclic epoxy resin. Specific examples of the first epoxy resin may include bisphenol type epoxy resins such as a bisphenol A type epoxy resin and a bisphenol F type epoxy resin; novolac type epoxy resins such as a bisphenol A novolac type epoxy resin and a cresol novolac type epoxy resin; and modified epoxy resins such as an urethane modified epoxy resin and a rubber modified epoxy resin. Further, other specific example may include a biphenyl type epoxy resin, a stilbene type epoxy resin, a triphenol methane type epoxy resin, an alkyl-modified triphenol methane type epoxy resin, a triazine nucleuscontain epoxy resin, a dicyclopentadiene-modified phenol type epoxy resin, a naphthalene type epoxy resin, a glycol type epoxy resin, and a pentaerythritol type epoxy resin. The first epoxy resin may be one kind, and may be 2 kinds or more.

The bisphenol A type epoxy resin may be present in a liquid state at room temperature or in a solid state at room temperature according to the number of repeating units of the bisphenol skeleton. The bisphenol A type epoxy resin wherein the bisphenol skeleton of the main chain is, for example, 2 or more and 10 or less is solid at room temperature. In particular, the bisphenol A type epoxy resin is preferable in that heat resistance may be improved.

Particularly, the first epoxy resin is preferably a bisphenol A novolac type epoxy resin represented by the following general formula (1).

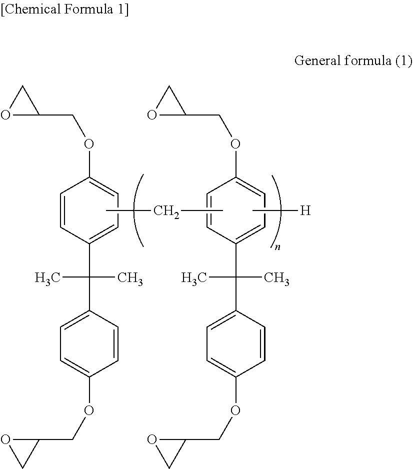

In general formula (1), R₁ is a group represented by CₘH₂ₘ (“m” is 1 or more and 3 or less), R₂ and R₃ are respectively and independently a group represented by CₚH₂ₚ₊₁ (“p” is 1 or more and 3 or less) , and “n” is 0 or more and 10 or less.

In general formula (1), “m” in R₁ is preferably 1, that is, R₁ is preferably —CH₂—. Similarly, “p” in R₂ and R₃ is preferably 1, that is, R₂ and R₃ are preferably —CH₃. Also, the hydrogen that bonds to the benzene ring of general formula (1) may be substituted with other element or other group.

The content of the first epoxy resin when the resin component included in the adhesive composition is regarded as 100 mass parts is, for example, 1 mass part or more, may be 3 mass parts or more, may be 5 mass parts or more, may be 10 mass parts or more, may be 15 mass parts or more, and may be 25 mass parts or more. When the content of the first epoxy resin is too low, the adhesiveness and the blocking resistance may be deteriorated. Meanwhile, the content of the first epoxy resin when the resin component included in the adhesive composition is regarded as 100 mass parts is, for example, 90 mass parts or less, may be 80 mass parts or less, may be 70 mass parts or less, may be 60 mass parts or less, may be 50 mass parts or less, and may be 40 mass parts or less. When the content of the first epoxy resin is too high, the content of the second epoxy resin and the acrylic resin will be relatively low so that the blocking resistance, the adhesiveness, and the crack resistance may not be compatible.

(2) Second Epoxy Resin

The softening temperature of the second epoxy resin is higher than the first epoxy resin and the weight-average molecular weight is 20,000 or more. The second epoxy resin has relatively high softening temperature (has relatively low crystallinity), compared to the above described first epoxy resin. Since the second epoxy resin has relatively low crystallinity and has high a weight-average molecular weight, the blocking resistance is easily improved. Further, since the second epoxy resin has relatively low crystallinity and has high a weight-average molecular weight, the increase of the pressure-sensitive adhesiveness (tack property) due to the first epoxy resin may be suppressed. Also, the second epoxy resin is preferably a solid epoxy resin at room temperature (23° C.)

The weight-average molecular weight (Mw) of the second epoxy resin is usually higher than the weight-average molecular weight (Mw) of the first epoxy resin. Mw of the second epoxy resin is usually, 20,000 or more, may be 30,000 or more, and may be 35,000 or more. Meanwhile, Mw of the second epoxy resin is, for example, 100,000 or less.

The epoxy equivalent of the second epoxy resin may be higher than, less than, or equal to the epoxy equivalent of the first epoxy resin. The epoxy equivalent of the second epoxy resin is, for example, 4000 g/eq or more, may be 5000 g/eq or more, and may be 6000 g/eq or more. Meanwhile, the epoxy equivalent of the second epoxy resin is, for example, 20000 g/eq or less.

The second epoxy resin may be a monofunctional epoxy resin, may be a bifunctional epoxy resin, may be a trifunctional epoxy resin, and may be a polyfunctional epoxy resin with four or more functional groups.

The softening temperature of the second epoxy resin is usually higher than the softening temperature of the first epoxy resin. The difference between the two is, for example, 10° C. or more, may be 20° C. or more, and may be 30° C. or more. The softening temperature of the second epoxy resin is, for example, 80° C. or more, and may be 90° C. or more. Meanwhile, the softening temperature of the second epoxy resin is, for example, 180° C. or less.

The configuration of the second epoxy resin is similar to that of the above describe first epoxy resin; thus, the description herein is omitted.

The content of the second epoxy resin when the resin component included in the adhesive composition is regarded as 100 mass parts is, for example, 10 mass parts or more, may be 15 mass parts or more, may be 20 mass parts or more, may be 25 mass parts or more, may be 30 mass parts or more, may be 35 mass parts or more, may be 40 mass parts or more, and may be 45 mass parts or more. When the content of the second epoxy resin is too low, the blocking resistance may be deteriorated. Meanwhile, the content of the second epoxy resin when the resin component included in the adhesive composition is regarded as 100 mass parts is, for example, 90 mass parts or less, may be 85 mass parts or less, may be 80 mass parts or less, and may be 75 mass parts or less. When the content of the second epoxy resin is too high, the content of the first epoxy resin and the acrylic resin will be relatively low so that the blocking resistance, the adhesiveness, and the crack resistance may not be compatible.

The proportion of the first epoxy resin with respect to the total of the first epoxy resin and the second epoxy resin is, for example, 5 mass % or more, may be 10 mass % or more, may be 15 mass % or more, and may be 20 mass % or more. Meanwhile, the proportion of the first epoxy resin is, for example, 80 mass % or less, may be 75 mass % or less, and may be 60 mass % or less.

Also, the proportion of the total of the first epoxy resin and the second epoxy resin with respect to all the epoxy resin included in the adhesive composition is, for example, 50 mass % or more, may be 70 mass % or more, may be 90 mass % or more, and may be 100 mass %.

2. Acrylic Resin

The acrylic resin in the present disclosure is a resin compatibilized with the epoxy resin, and is a resin having the weight-average molecular weight of 50,000 or more. Since the acrylic resin is compatible with the epoxy resin, the toughness of the adhesive layer is likely to be improved. As the result, the crack resistance may be improved. Also, by improving the toughness of the adhesive layer, the adhesiveness may be improved. Further, the acrylic resin is believed to function as a compatibilizing agent of the foaming agent (such as a foaming agent whose shell part is an acrylonitrile copolymer resin), and the adhesiveness is improved by being uniformly dispersed and foamed. Also, the crystallinity of the first epoxy resin is relatively high so that a shrinkage may occur during curing after foaming (the term from the completion of foaming of the foaming agent until the adhesive composition is cured), since the melt viscosity (or dynamic viscoelasticity) during heating is too low. However, by using an acrylic resin having molecular weight of a certain level, the melt viscosity may be suppressed from being too low so that the shrinkage during curing after foaming is not likely to occur. Also, the hardness of the adhesive layer surface may be maintained at high level, by the acrylic resin being compatibilizing with the epoxy resin. Also, if the acrylic resin is incompatible, a soft part is formed on the sheet surface so that the interface with the adherend is not slippery enough when formed into a sheet form, and the workability may be deteriorated.

The acrylic resin in the present disclosure is compatibilized with the epoxy resin. Here, the state that the acrylic resin being compatibilized with the epoxy resin may be confirmed by, for example, producing an adhesive layer using the adhesive composition, observing the cross-section of the adhesive layer with a scanning electron microscope (SEM) or a transmission electron microscope (TEM), and a micron sized island not being confirmed. More specifically, the average particle size of the island is preferably 1 μm or less. Among the above, the average particle size of the island may be 0.5 μm or less, and may be 0.3 μm or less. The number of the sample is preferably large, and is, for example, 100 or more. The area of the observed region is in a range of 100 μm×100 μm or, when the thickness of the adhesive layer is 100 μm or less, the observation is carried out in a range of thickness×100 μm.

The weight-average molecular weight (Mw) of the acrylic resin is, for example, 50,000 or more, may be 70,000 or more, and may be 100,000 or more. Meanwhile, Mw of the acrylic resin is, for example, 1,500,000 or less. The weight-average molecular weight of the acrylic resin may be measured by GPC (eluent: THF, standard substance: PS, sample: 20 μl, flow: 1 ml/min, column temperature: 40° C.)

The glass transition temperature (Tg) of the acrylic resin is, for example, 90° C. or more, and may be 100° C. or more. Meanwhile, Tg of the acrylic resin is, for example, 180° C. or less. Tg may be measured by a thermal analysis such as differential scanning calorimetry (DSC) according to JIS K 7121.

The storage elastic modulus (E′) of the acrylic resin at a foaming start temperature may be 1×10⁶ Pa or less. By E′ being low at the start of the foaming, the flowability is improved so that preferable foaming ability may be obtained. Meanwhile, E′ at the foaming start temperature is, for example, 1×10⁵ Pa or more. Incidentally, the foaming start temperature is a temperature that varies according to the kind of the foaming agent. Also, when two kinds or more of the foaming agents are used as the foaming agent, the foaming start temperature is regarded as the start temperature of the main foaming reaction.

The storage elastic modulus (E′) of the acrylic resin at a curing start temperature may be 1×10⁵ Pa or more. As described above, the shrinkage may occur during curing after foaming (the term from the completion of foaming of the foaming agent until the adhesive composition is cured). However, the shrinkage may be suppressed and preferable shape maintaining property may be obtained by E′ being high at the curing start temperature. Incidentally, the curing start temperature is a temperature that varies according to the kind of the curing agent. Also, when two kinds or more of the curing agents are used as the curing agent, the curing start temperature is regarded as the start temperature of the main curing reaction.

Also, the average value of the storage elastic modulus (E′) of the acrylic resin at 0° C. or more and 100° C. or less may be 1×10⁶ Pa or more. A preferable blocking resistance may be obtained by the average value of E′ before the foaming being high. Meanwhile, the average value of the storage elastic modulus (E′) at 0° C. or more and 100° C. or less is, for example, 1×10⁸ Pa or less.

The acrylic resin may include a polar group. Examples of the polar group may include an epoxy group, a hydroxyl group, a carboxyl group, a nitrile group, and an amide group.

The acrylic resin may be a homopolymer of acrylic acid ester monomers that are mixture component including two kinds or more of the above described homopolymer, and may be a copolymer of two kinds or more acrylic acid ester monomers that is a component including one or more copolymer. Also, the acrylic resin may be mixture components of the homopolymer and the copolymer. The “acrylic acid” in the acrylic acid ester monomers includes the concept of a methacrylic acid. Specifically, the acrylic resin may be a mixture of the methacrylate polymer and the acrylate polymer, and may be an acrylic acid ester polymer such as acrylate-acrylate, methacrylate-methacrylate, and methacrylate-acrylate. Among them, the acrylic resin preferably includes a copolymer of two kinds or more acrylic acid ester monomers ((meth)acrylic acid ester copolymer).

Examples of the monomer component constituting the (meth)acrylic acid ester copolymer may include the monomer component described in Japanese Patent Application Laid-Open (JP-A) No. 2014-065889. The monomer component may include the above described polar group. Examples of the (meth)acrylic acid ester copolymer may include an ethyl acrylate-butyl acrylate-acrylonitrile copolymer, an ethyl acrylate-acrylonitrile copolymer, and a butyl acrylate-acrylonitrile copolymer. Incidentally, the “acrylic acid” in, for example, acrylic acid methyl and acrylic acid ethyl include “methacrylic acid” in, for example, (meth)acrylic acid methyl and (meth)acrylic acid ethyl.

As the (meth) acrylic acid ester copolymer, a block copolymer is preferable, and an acrylic block copolymer such as a methacrylate-acrylate copolymer is further preferable. Examples of the (meth) acrylate constituting the acrylic block copolymer may include methyl acrylate, ethyl acrylate, propyl acrylate, butyl acrylate, lauryl acrylate, 2-ethylhexyl acrylate, cyclohexyl acrylate, and benzyl acrylate. These “acrylic acid” also includes “methacrylic acid”.

Specific examples of the methacrylate-acrylate copolymer may include acrylic copolymers such as methyl methacrylate-butyl acrylate-methyl methacrylate (MMA-BA-MMA) copolymers. MMA-BA-MMA copolymers also include block copolymers of polymethylmethacrylate-polybutylacrylate-polymethylmethacrylate (PMMA-PBA-PMMA).

The acrylic copolymer may not include a polar group, and may be a modified product wherein the above described polar group is introduced into a part. Since the modified product is easily compatible with an epoxy resin, adhesiveness is further improved.

Among them, the acrylic resin is preferably a (meth) acrylic acid ester copolymer including a first polymer portion having a glass transition temperature (Tg) of 10° C. or less, and a second polymer portion having a glass transition temperature (Tg) of 20° C. or more. Such a (meth) acrylic acid ester copolymer includes a first polymer portion to be a soft segment and a second polymer portion to be a hard segment.

The expression of the above effect may be estimated as follows. By using an acrylic resin including both of a soft segment and a hard segment, such as the above (meth) acrylic acid ester copolymer, the hard segment contributes to heat resistance, and the soft segment contributes to toughness or flexibility, so that an adhesive layer having good heat resistance, toughness, and flexibility may be obtained.

At least one of the first polymer portion and the second polymer portion contained included in the above (meth) acrylic acid ester copolymer has compatibility with the epoxy resin. When the first polymer portion has compatibility with the epoxy resin, flexibility may be increased. Also, when the second polymer portion has compatibility with the epoxy resin, it is possible to enhance the cohesiveness and toughness.

When one of the first polymer portion and the second polymer portion has no compatibility with the epoxy resin, the (meth) acrylic acid ester copolymer includes a compatible site that is a polymer portion compatible with the epoxy resin and a incompatible site that is a polymer portion not compatible with the epoxy resin. In this case, when the above (meth) acrylic acid ester copolymer is added to the adhesive composition, the compatible site is compatibilized with the epoxy resin, and the incompatible site is not compatibilized with the epoxy resin, so that fine phase separation occurs. As the result, a fine sea-island structure is developed. The sea-island structure differs according to the type of the (meth) acrylic acid ester copolymer, the compatibility of the first polymer portion and the second polymer portion included in the (meth) acrylic acid ester copolymer, and the existence or non-existence of modification by introducing a polar group. Examples thereof may include a sea-island structure wherein a cured product of the epoxy resin and a compatible site of the (meth) acrylic acid ester copolymer are sea, and a non-compatible site of the (meth) acrylic acid ester copolymer is an island; a sea-island structure wherein a non-compatible site of the (meth) acrylic acid ester copolymer is a sea, and a cured product of the epoxy resin and a compatible site of the (meth) acrylic acid ester copolymer are an island; and a sea-island structure wherein the (meth) acrylic acid ester copolymer is a sea, and a cured product of the epoxy resin is an island. By having such a sea-island structure, it is possible to easily disperse the stress, so that it is possible to avoid interfacial breakage and to obtain excellent adhesiveness after foamed and cured.

Among the above, the (meth) acrylic acid ester copolymer is preferably a block copolymer, and in particular, preferably an A-B-A block copolymer including a polymer block A as a compatible site and a polymer block B as a non-compatible site is preferable. Further, it is preferable to be a A-B-A block copolymer wherein the first polymer portion is a non-compatible site and the second polymer portion is a compatible site, and the first polymer portion is a polymer block B and the second polymer portion is a polymer block A. By using such an A-B-A block copolymer as an acrylic resin, the island portion may be decreased in the sea-island structure wherein a cured product of the epoxy resin and a compatible site of the (meth) acrylic acid ester copolymer are sea, and a non-compatible site of the (meth) acrylic acid ester copolymer is an island. Also, the sea portion may be reduced in the case of the sea-island structure wherein a non-compatible site of the (meth) acrylic acid ester copolymer is a sea, a cured product of the epoxy resin, and a compatible site of the (meth) acrylic acid ester copolymer are islands; or in the case of the sea-island structure wherein the (meth) acrylic acid ester copolymer is a sea and a cured product of the epoxy resin is an island.

Further, the above (meth) acrylic acid ester copolymer may be a modified product obtained by introducing the above mentioned polar group into a part of the first polymer portion or the second polymer portion.

The Tg of the first polymer portion included in the (meth) acrylic acid ester copolymer may be 10° C. or less, may be in a range of −150° C. or more and 10° C. or less, among the above, in a range of −130° C. or more and 0° C. or less, particularly in a range of −110° C. or more and -10° C. or less.

Incidentally, Tg of the first polymer portion may be determined by calculating according to the following formula based on Tg (K) of each homopolymer described in “POLYMERHANDBOOK 3rd Edition” (issued by John Wiley & Sons, Ink.)

1/Tg(K)=W₁/Tg₁+W₂/Tg₂+ . . . +Wₙ/Tgₙ

Wₙ; mass fraction of each monomer

Tgₙ; Tg (K) of the homopolymer of the each monomer and publicly available listed values such as those in the Polymer Handbook (3rd Ed., J. Brandrup and E. H. Immergut, WILEY INTERSCIENCE) may be used. The same applies to Tg of the second polymer portion described later.

The first polymer portion included in the above (meth) acrylic acid ester copolymer may be a homopolymer, and may be a copolymer; among them, a homopolymer is preferable. The monomer component and the polymer component constituting the first polymer portion may be any monomer component and a polymer component capable of obtaining a first polymer portion with Tg in a predetermined range, and examples thereof may include acrylic acid ester monomers such as acrylic acid butyl, acrylic acid 2-ethylhexyl, acrylic acid isononyl, and acrylic acid methyl; other monomers such as vinyl acetate, acetal, and urethane; a polar group containing monomer including the above described polar group; and copolymers such as EVA.

The Tg of the second polymer portion included in the above (meth) acrylic acid ester copolymer is 20° C. or more, may be in a range of 20° C. or more and 150° C. or less, among the above, in a range of 30° C. or more and 150° C. or less, particularly in a range of 40° C. or more and 150° C. or less.

Also, the second polymer portion included in the above (meth) acrylic acid ester copolymer may be a homopolymer, may be a copolymer; among them, a homopolymer is preferable. The monomer component constituting the second polymer portion may be any monomer component capable of obtaining a second polymer portion with Tg in a predetermined range, and examples thereof may include acrylic acid ester monomers such as methyl methacrylate; other monomers such as acrylamide, styrene, vinyl chloride, amide, acrylonitrile, cellulose acetate, phenol, urethane, vinylidene chloride, methylene chloride, and methacrylonitrile; and a polar group containing monomers including the above described polar group.

Specific examples of the (meth) acrylic acid ester copolymer including the first polymer portion and the second polymer portion described above may include the above described MMA-BA-MMA copolymers.

The content of the acrylic resin when the resin component included in the adhesive composition is regarded as 100 mass parts is, for example, 1 mass part or more, may be 3 mass parts or more, may be 5 mass parts or more, may be 7 mass parts or more, and may be 10 mass parts or more. When the content of the acrylic resin is too low, the crack resistance and the adhesiveness may be deteriorated. Meanwhile, the content of the acrylic resin when the resin component included in the adhesive composition is regarded as 100 mass parts is, for example, 60 mass parts or less, may be 50 mass parts or less, may be 40 mass parts or less, may be 35 mass parts or less, and may be 30 mass parts or less. When the content of the acrylic resin is too high, the content of the first epoxy resin and the second epoxy resin will be relatively low so that the blocking resistance, the adhesiveness, and the crack resistance may not be compatible.

3. Curing Agent

As the curing agent in the present disclosure, a curing agent generally used in an epoxy resin based adhesive may be used. The curing agent is preferably solid at 23° C. The curing agent that is solid at 23° C. may improve storage stability (pot life) compared to the curing agent that is liquid at 23° C. Also, the curing agent may be a latent curing agent. Also, the curing agent may be a curing agent wherein a curing reaction occurs by heat, and may be a curing agent wherein a curing reaction occurs by light. Also, in the present disclosure, a curing agent may be used alone, and 2 kinds or more of them may be used.

The reaction start temperature of the curing agent is, for example, 110° C. or more, and may be 130° C. or more. If the reaction start temperature is too low, the reaction may be started early, and curing may occur in a condition where the flexibility and fluidity of the resin component are low, and uniform curing may hardly occur. Meanwhile, the reaction start temperature of the curing agent is, for example, 200° C. or less. If the reaction start temperature is too high, there is a possibility that the resin component is deteriorated. Incidentally, in addition to the epoxy resin, for example, when a resin having high heat resistance such as a phenol resin is used, since deterioration of the resin component is small, the reaction start temperature of the curing agent may be, for example, 300° C. or less. The reaction start temperature of the curing agent may be determined by differential scanning calorimetry (DSC).

Specific examples of the curing agent may include an imidazole based curing agent, a phenol based curing agent, an amine based curing agent, an acid anhydride based curing agent, an isocyanate based curing agent, and a thiol based curing agent.

Examples of the imidazole curing agent may include imidazoles, 2-phenyl-4,5-dihydroxymethylimidazole, 2-phenyl-4-methyl-5-hydroxymethylimidazole, 2-methylimidazole, 2-ethylimidazole, 2-ethyl-4-methylimidazole, 2-isopropylimidazole, 2-phenylimidazole, carboxylates of imidazole compounds, and adducts with epoxy compounds. Also, it is preferable that the imidazole based curing agent includes a hydroxyl group. Since it crystallizes by hydrogen bonding between hydroxy groups, the reaction start temperature tends to be high.

Examples of the phenol based curing agent may include phenol resins. Further, examples of the phenol resin may include a resol type phenol resin and a novolac type phenol resin. From the viewpoint of crack resistance, for example a phenol type novolac resin having a Tg of 110° C. or less is particularly preferable. Also, a phenol based curing agent and an imidazole based curing agent may be used in combination. In this case, it is preferable to use an imidazole based curing agent as a curing catalyst.

Examples of the amine based curing agent may include aliphatic amines such as diethylenetriamine (DETA), triethylenetetramine (TETA), and meth-xylylenediamine (MXDA); aromatic amines such as diaminodiphenylmethane (DDM), m-phenylenediamine (MPDA), and diaminodiphenylsulfone (DDS); alicyclic amines; and polyamidoamines. Also, as an amine based curing agent, a dicyandiamide based curing agent such as dicyandiamide (DICY); an organic acid dihydrazide based curing agent; an amine adduct based curing agent; and a ketimine based curing agent may be used.

Examples of the acid anhydride based curing agent may include alicyclic acid anhydrides (liquid acid anhydrides) such as hexahydrophthalic anhydride (HHPA) and methyltetrahydrophthalic anhydride (MTHPA); and aromatic acid anhydrides such as trimellitic anhydride (TMA), pyromellitic dianhydride (PMDA), and benzophenone tetracarboxylic dianhydride (BTDA).

Examples of the isocyanate based curing agent may include blocked isocyanate.

Examples of the thiol based curing agent may include an ester bond type thiol compound, an aliphatic ether bond type thiol compound, and an aromatic ether bond type thiol compound.

The content of the curing agent when the resin component included in the adhesive composition is regarded as 100 mass parts is, for example, 1 mass part or more and 40 mass parts or less. For example, when an imidazole based curing agent is used as a main component as the curing agent, the content of the curing agent when the resin component included in the adhesive composition is regarded as 100 mass parts is preferably, for example, 1 mass part or more and 15 mass parts or less. On the other hand, when a phenol based curing agent is used as the main component as a curing agent, the content of the curing agent when the resin component included in the adhesive composition is regarded as 100 mass parts is preferably, for example, 5 mass parts or more and 40 mass parts or less. Incidentally, the use of an imidazole based curing agent or a phenol based curing agent as a main component as the curing agent means that the mass ratio of the imidazole based curing agent or the phenol based curing agent is the highest in the curing agent.

4. Foaming Agent

As the foaming agent in the present disclosure, a foaming agent generally used for an adhesive layer of a foaming adhesive sheet may be used. Also, the foaming agent may be a foaming agent wherein a foaming reaction occurs by heat, and may be a foaming agent wherein a foaming reaction occurs by light.

It is preferable that the foaming start temperature of the foaming agent is the softening temperature of the epoxy resin or more and also, the activation temperature of the curing reaction of the epoxy resin or less. Incidentally the softening temperature of the epoxy resin may be measured using the ring and ball type softening temperature testing method specified in JIS K 2207. The foaming start temperature of the foaming agent is, for example, 70° C. or more, and may be 100° C. or more. If the reaction start temperature is too low, the reaction may be started early, and foaming may occur in a condition where the flexibility and fluidity of the resin component are low, and uniform foaming may hardly occur. Meanwhile, the reaction start temperature of the foaming agent is, for example, 210° C. or less. If the reaction start temperature is too high, there is a possibility that the resin component is deteriorated.

Examples of the foaming agent may include an organic based foaming agent and an inorganic based foaming agent. Examples of the organic based foaming agent may include azo foaming agents such as azodicarbonamide (ADCA), azobisformamide, and azobisisobutyronitrile; a fluorinated alkane based foaming agents such as trichloromonofluoromethane; a hydrazine based foaming agents such as paratoluenesulfonylhydrazide; a semicarbazide based foaming agents such as p-toluenesulfonylsemicarbazide; a triazole based foaming agent such as 5-morpholyl-1,2,3,4-thiatriazole; and N-nitroso based foaming agents such as a N,N-dinitrosoterephthalamide. Meanwhile, examples of the inorganic based foaming agent may include ammonium carbonate, ammonium hydrogencarbonate, ammonium nitrite, ammonium borohydride, and azides.

Also, a microcapsule type foaming agent may be used as the foaming agent. It is preferable that the microcapsule type foaming agent includes a thermal expansion agent such as a hydrocarbon as a core and a resin such as an acrylonitrile copolymer as a shell.

The foaming magnification of the foaming agent is, for example, 1.5 times or more, and may be 3 times or more. Meanwhile, the foaming magnification of the foaming agent is, for example, 15 times or less, and may be 10 times or less.

The content of the foaming agent when the resin component included in the adhesive composition is regarded as 100 mass parts is, for example, 0.5 mass parts or more, and may be 2 mass parts or more. Meanwhile, the content of the foaming agent is, for example, 20 mass parts or less, and may be 15 mass parts or less.

5. Adhesive Composition

The adhesive composition in the present disclosure comprises at least an epoxy resin and an acrylic resin described above as the resin component. The adhesive composition may include only the epoxy resin and the acrylic resin as the resin component, and may further include other resins. Examples of the other resin may include urethane resins. The proportion of the total of the first epoxy resin, the second epoxy resin and the acrylic resin with respect to the resin component included in the adhesive composition is, for example, 70 mass % or more, may be 80 mass % or more, may be 90 mass % or more, and may be 100 mass %.

The proportion of the resin component in the solid components of the adhesive composition is, for example, 60 mass % or more, may be 70 mass % or more, may be 80 mass % or more, and may be 90 mass % or more.

The adhesive composition may include, if necessary, a silane coupling agent, a filler, an antioxidant, a light stabilizer, an ultraviolet absorber, a lubricant, a plasticizer, an antistatic agent, a crosslinking agent, and a colorant. Examples of the silane coupling agent may include an epoxy based silane coupling agent. Examples of the filler may include inorganic fillers such as calcium carbonate, aluminum hydroxide, magnesium hydroxide, antimony trioxide, zinc borate, molybdenum compounds, and titanium dioxide. Examples of the antioxidant may include a phenol based antioxidant and a sulfur based antioxidant.

The adhesive composition may include a solvent and may not include a solvent. Incidentally, the solvent in the present specification is in a broad sense including not only a strict solvent (a solvent for dissolving a solute) but also a dispersion medium. Also, the solvent included in the adhesive composition is volatilized and removed when the adhesive composition is applied and dried to form an adhesive layer.

The adhesive composition in the present disclosure may be obtained by mixing each of the above described components and kneading and dispersing them if necessary. Examples of the mixing and dispersing methods may include common kneading dispersers such as twin roll mills, triple roll mills, pebble mills, trommels, Szegvari attritors, high-speed impeller dispergators, high-speed stone mills, high-speed impact mills, Despar, high-speed mixers, ribbon blenders, cokneaders, intensive mixers, tumblers, blenders, dispersers, homogenizers, and ultrasonic dispergators.

The use of the adhesive composition in the present disclosure is not particularly limited, and is preferably used for an adhesive layer of a foaming adhesive sheet. Also, the adhesive composition in the present disclosure may be used as an adhesive as it is.

B. Foaming Adhesive Sheet

The foaming adhesive sheet in the present disclosure comprises at least an adhesive layer, wherein the adhesive layer includes an epoxy resin, an acrylic resin compatibilized with the epoxy resin, a curing agent, and a foaming agent, as the epoxy resin, the adhesive layer includes a first epoxy resin with a softening temperature of 50° C. or more and an epoxy equivalent of 5000 g/eq or less, and a second epoxy resin with a softening temperature higher than the first epoxy resin and a weight-average molecular weight of 20,000 or more, and a weight-average molecular weight of the acrylic resin is 50,000 or more.

Incidentally, in the present specification, “sheet” includes a member referred to as “film”. Also, “film” includes a member referred to as “sheet”.

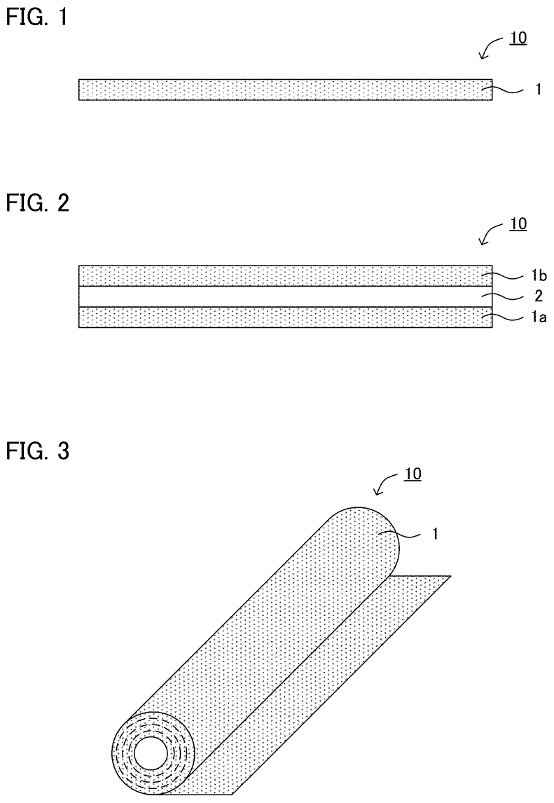

FIG. 1 and FIG. 2 are schematic cross-sectional views illustrating an example of a foaming adhesive sheet in the present disclosure. Foaming adhesive sheet 10 in FIG. 1 comprises only adhesive layer 1. Foaming adhesive sheet 10 in FIG. 2 comprises first adhesive layer 1a, substrate 2, and second adhesive layer 1b in this order in the thickness direction. Also, FIG. 3 is a schematic perspective view illustrating an example of a foaming adhesive sheet in the present disclosure. Foaming adhesive sheet 10 in FIG. 3 is rolled up so as one surface and another surface of the adhesive layer 1 are in contact with each other. Incidentally, although not shown in the figure, the foaming adhesive sheet in the present disclosure may be rolled up so as first adhesive layer la and second adhesive layer 1b in FIG. 2 are in contact with each other.

According to the present disclosure, a foaming adhesive sheet with good blocking resistance, adhesiveness, and crack resistance may be obtained since the adhesive layer includes a specific epoxy resin and a specific acrylic resin. Also, since the foaming adhesive sheet in the present disclosure has good blocking resistance, there is no need to provide a releasing layer of a releasing sheet for the purpose of preventing the blocking.

1. Adhesive Layer

The foaming adhesive sheet in the present disclosure comprises at least an adhesive layer. The adhesive layer includes at least an epoxy resin, an acrylic resin, a curing agent, and a foaming agent. These materials may be in the same contents as those described in “A. Adhesive composition” above; thus, the description herein is omitted.

The thickness of the adhesive layer is not particularly limited, and is, for example, 10 μm or more, and may be 20 μm or more. When the adhesive layer is too thin, a sufficient adhesiveness may not be obtained. Meanwhile, the thickness of the adhesive layer is, for example, 200 μm or less.

The adhesive layer in the present disclosure is preferably non-pressure-sensitive adhesive (tack free). The non-pressure-sensitive adhesive is generally used mainly to mean low pressure-sensitive adhesiveness. In the present disclosure, being “non-pressure-sensitive adhesive” is referred to a condition that a rolled up foaming adhesive sheet may be easily unrolled without reluctance. Also, if, for example, the pressure-sensitive adhesive force is 0 (N/25 mm) or more and 0.1 (N/25 mm) or less by the measurement (adherend: SUS304 BA) based on JIS Z 0237 (10.4.1_180° peeling), it may be determined as non-pressure-sensitive adhesive.

The adhesive layer may be a continuous layer, and may be a discontinuous layer. Example of the discontinuous layer may include patterns such as stripes and dots. Also, the surface of the adhesive layer may have a concavo-convex shape such as emboss.

The adhesive layer may be formed, for example, by applying an adhesive composition and removing a solvent. Examples of application methods may include roll coating, reverse roll coating, transfer roll coating, gravure coating, gravure reverse coating, comma coating, rod coating, blade coating, bar coating, wire bar coating, die coating, lip coating, and dip coating.

2. Substrate

The foaming adhesive sheet in the present disclosure may include a substrate. The substrate preferably has an insulating property. Also, it is preferable that the substrate is in a sheet form. The substrate sheet may have a single layer structure, and may have a multiple layer structure. Also, the substrate sheet may or may not have a porous structure inside.

Examples of the substrate may include a resin and a nonwoven fabric. Examples of the resin may include polyester resins such as polyethylene terephthalate (PET), polybutylene terephthalate, polyethylene naphthalate (PEN), and aromatic polyesters; polycarbonates; polyarylates; polyurethanes; polyamide resins such as polyamides, and polyetheramides; polyimide resins such as polyimides, polyetherimides, and polyamideimides; polysulfone resins such as polysulfones, polyethersulfones; polyetherketone resins such as polyetherketones, and polyether ether ketones; polyphenylene sulfides (PPS); and modified polyphenylene oxides. The glass transition temperature of the resin is, for example, 80° C. or more, may be 140° C. or more, and may be 200° C. or more. Also, a liquid crystal polymer (LCP) may be used as the substrate.

Meanwhile, examples of the nonwoven fabric may include nonwoven fabrics including fibers such as cellulose fibers, polyester fibers, nylon fibers, aramid fibers, polyphenylene sulfide fibers, liquid crystal polymer fibers, glass fibers, metal fibers, and carbon fibers.

The thickness of the substrate is not particularly limited, and is, for example, 2 μm or more, may be 5 μm or more, and may be 9 μm or more. Meanwhile, the thickness of the substrate is, for example, 200 μm or less, may be 100 μm or less, and may be 50 μm or less.

3. Foaming Adhesive Sheet

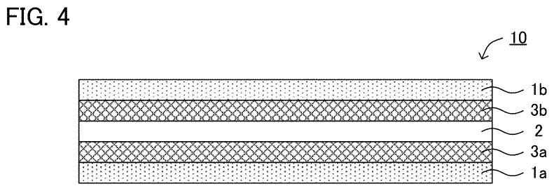

The foaming adhesive sheet in the present disclosure may include a stress releasing layer between the substrate and the adhesive layer. By providing the stress releasing layer, the crack resistance of the adhesive layer is further improved, and the adhesiveness of the substrate and the adhesive layer is also improved. For example, in foaming adhesive sheet 10 in FIG. 4, first adhesive layer la, substrate 2, and second adhesive layer 1b are placed in this order in the thickness direction, and first stress releasing layer 3a is placed between first adhesive layer la and substrate 2, and second stress releasing layer 3b is placed between substrate 2 and second adhesive layer 1b. Incidentally, foaming adhesive sheet 10 in FIG. 4 includes both first stress releasing layer 3a and second stress releasing layer 3b; however, it may include only either one of them.

It is preferable that the stress releasing layer includes a resin and a curing agent. Examples of the resin may include polyester, polyvinyl chloride, polyvinyl acetate, polyurethane, and a polymer obtained by copolymerizing at least 2 kinds or more of them. Meanwhile, examples of the curing agent may include an isocyanate based curing agent. Also, for example, when the reactive group/NCO equivalent is regarded as 1, it is preferable to add an isocyanate based curing agent to a resin (such as polyester) at the proportion of 0.5 mass % or more and 10 mass % or less.

The thickness of the stress releasing layer is not particularly limited, and is, for example, 0.1 μm or more, may be 0.2 μm or more, and may be 0.5 μm or more. If the stress releasing layer is too thin, there is a possibility that sufficient crack resistance improving effect may not be obtained. Meanwhile, the thickness of the stress releasing layer is, for example, 10 μm or less. Since the heat resistance of the stress releasing layer itself is usually not high, if the stress releasing layer is too thick, the heat resistance (adhesive strength under high temperature) may be reduced.

When the foaming adhesive sheet in the present disclosure includes the stress releasing layer, the adhesive layer may include a phenol resin. The addition of the phenol resin may improve the heat resistance; meanwhile, the crack resistance may be lowered. In contrast to this, by providing the stress releasing layer, it is possible to suppress the deterioration of the crack resistance even when the adhesive layer includes the phenol resin. As the result, it is possible to obtain a foaming adhesive sheet achieving both of the improvement in heat resistance and the suppression of deterioration in crack resistance. The phenol resin is preferably a biphenyl type from the viewpoint of the heat resistance. Also, the phenol resin may be a resin obtained by modifying a phenol nucleus. By modifying the phenol nucleus, for example, the heat resistance may be further improved.

The stress releasing layer may be formed, for example, by applying a resin composition and removing a solvent. Examples of application methods may include roll coating, reverse roll coating, transfer roll coating, gravure coating, gravure reverse coating, comma coating, rod coating, blade coating, bar coating, wire bar coating, die coating, lip coating, and dip coating.

The thickness of the foaming adhesive sheet in the present disclosure is, for example, 10 μm or more, and may be 20 μm or more. Meanwhile, the thickness of the foaming adhesive sheet is, for example, 1000 μm or less, and may be 200 μm or less.

It is preferable that the foaming adhesive sheet in the present disclosure has good shape retainability. The bending moment based on JIS P 8125 is, for example, 40 gf·cm or more, and may be 50 gf·cm or more. Meanwhile, the bending moment is, for example, 600 gf·cm or less and 150 gf·cm or less.

It is preferable that the foaming adhesive sheet in the present disclosure has high adhesiveness after foamed and cured. The shear strength (adhesive strength) based on JIS K 6850 is preferably 2.10 MPa or more, more preferably 2.40 MPa or more, and further preferably 3.0 MPa or more at 23° C. Also, the shear strength (adhesive strength) is preferably 0.28 MPa or more, and more preferably 0.30 MPa or more at 200° C.

It is preferable that the foaming adhesive sheet in the present disclosure has high electrical insulation after foamed and cured. The dielectric breakdown voltage based on JIS C 2107 is preferably 3 kV or more, and more preferably 5 kV or more. Also, the foaming adhesive sheet after foamed and cured preferably has a thermal conductivity of 0.1 W/mK or more, and more preferably 0.15 W/mK or more.

The use of the foaming adhesive sheet in the present disclosure is not particularly limited. For example, the foaming adhesive sheet in the present disclosure may be used for adhesion of coils and stators in a motor.

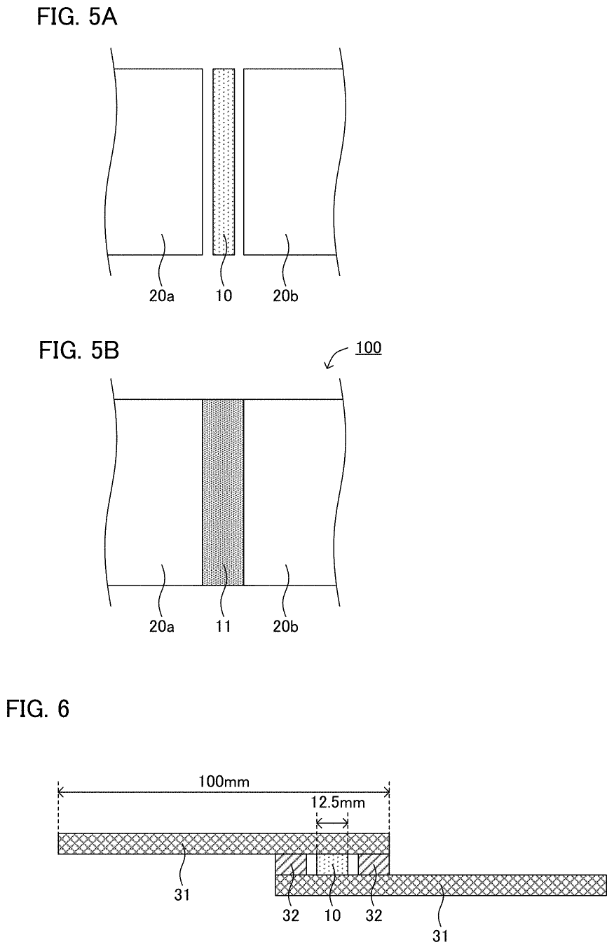

Also, in the present disclosure, it is possible to provide a method for producing a product using the above described foaming adhesive sheet. In other words, it is possible to provide a method for producing a product comprising a placing step of placing the foaming adhesive sheet described above between a first member and a second member, and an adhering step of foaming and curing the foaming adhesive sheet and adhering the first member and the second member. For example, as shown in FIG. 5, foaming adhesive sheet 10 described above is placed between first member 20a and second member 20b (FIG. 5A, placing step). Next, for example, by heating, foaming adhesive sheet 10 is foamed and cured (FIG. 5B, adhering step). First member 20a and second member 20b are adhered (joined) by adhesive sheet 11 after foamed and cured.

Incidentally, the present disclosure is not limited to the embodiments. The embodiments are exemplification, and any other variations are intended to be included in the technical scope of the present disclosure if they have substantially the same constitution as the technical idea described in the claim of the present disclosure and offer similar operation and effect thereto.

### EXAMPLES

### Examples 1 to 12, Comparative Examples 1 to 4

An adhesive composition having a composition (mass %) shown in Table 1 and Table 2 below was prepared. Incidentally, although not described in Table 1 and Table 2, the adhesive composition included ethyl acetate as a solvent, and all of them were adjusted so as to have a solid concentration of 35 mass %. Also, details of each material described in Table 1 and Table 2 are shown in Table 3.

Next, a polyphenylene sulfide film (PPS film, thickness: 100 μm) having high insulating property was prepared as a substrate, and the adhesive composition was applied to one surface of this substrate using an applicator so that a thickness after coating was 45 μm to 55 μm. Thereafter, it was dried for 3 minutes at 100° C. in a drying oven to form an adhesive layer. An adhesive layer was similarly formed on the other surface of the substrate to obtain a foaming adhesive sheet wherein the adhesive layer was formed on the front and back of the substrate, respectively.

[Evaluation]

<Blocking Resistance>

The obtained foaming adhesive sheet was cut out to 10 cm×10 cm, and 2 cut out sheets were staked. Blocking resistance was evaluated by storing in a blocking tester under the conditions of 3 kg/cm, 40° C., and dry for 3 days. The blocking resistance was evaluated according to the following criteria.

∘: There was no transfer or peeling of the adhesive layer, and the sheets came off by itself.

Δ: There was no transfer or peeling of the adhesive layer, and although the sheets did not come off by itself, they came off with a very light force.

×: There was a transfer or peeling of the adhesive layer, or the sheets did not come off by itself, and they were in close contact with each other so that a peeling noise was made.

<Crack Resistance>

The obtained foaming adhesive sheet was cut at a speed of 20 mm/s or more and 100 mm/s or less at a length of 100 mm by a cutter (Olfa cutter knife A plus), and whether a chipping occurred at the cut surface or not was confirmed. The crack resistance was evaluated based on the following criteria.

∘: There was no chipping or cracking at all at the cut surface.

×: The cut surface was chipped, and cracked resin was scattered.

<Adhesiveness>

As shown in FIG. 6, two aluminum pieces 31 (length 100 mm×width 25 mm×thickness 1.5 mm) were prepared. Spacers 32 (Kapton tape) were placed at predetermined intervals on one of the aluminum pieces 31. The thickness of the spacers were 351 μm (a thickness obtained by stacking five sheets of P-221 manufactured by Nitto Denko Co., Ltd.) or 418 μm (a thickness obtained by stacking six sheets of P-221 manufactured by Nitto Denko Co., Ltd.). The foaming adhesive sheet 10 cut to 12.5 mm×25 mm was placed between spacers 32, and another aluminum piece 31 was placed and fixed by clips to obtain a test piece.

The test piece was placed in a thermal oven and heated to cure the foaming adhesive sheet 10. Heating conditions were 150° C. for 30 minutes or 180° C. for 30 minutes. The shear strength (adhesive strength) of the heated test piece was measured by a Tensilon RTF1350 (manufactured by A & D Company, Ltd.) in accordance with JIS K 6850. The tensile speed was 10 mm/min. The measurement temperature was 23° C. or 200° C. Evaluation criteria (23° C.)

∘: 2.40 MPa or more

Δ: 2.10 MPa or more and less than 2.40 MPa

×: less than 2.10 MPa

Evaluation criteria (200° C.)

∘: 0.28 MPa or more

×: less than 0.28 MPa

TABLE 1

| | Ex. 1 | Ex. 2 | Ex. 3 | Ex. 4 | Ex. 5 | Comp.Ex.1 | Ex. 6 | Ex. 7 | Ex. 8 |
|---|---|---|---|---|---|---|---|---|---|
| Acrylic resin | 15.2 | 11.9 | 14.7 | 18.9 | 14.9 | 12.0 | 11.9 | 11.6 | 11.3 |
| Epoxy resin A1 | — | 3.3 | 3.2 | — | 3.2 | — | 4.6 | 4.5 | 4.3 |
| Epoxy resin A2 | 25.3 | 19.8 | 19.1 | 24.6 | 19.5 | — | 27.5 | 26.8 | 26.1 |
| Epoxy resin A3 | 4.2 | — | — | 4.1 | — | 32.4 | — | — | — |
| Epoxy resin B1 | — | 34.4 | 33.2 | — | 33.8 | — | 47.7 | 46.4 | 45.2 |
| Epoxy resin B2 | 43.9 | — | — | 42.7 | — | — | — | — | — |
| Epoxy resin C1 | — | — | — | — | — | 48.1 | — | — | — |
| Curing agent 1 | — | 19.8 | 19.1 | — | 19.5 | — | — | — | — |
| Curing agent 2 | 3.5 | 2.7 | 2.6 | 3.4 | 2.7 | 2.8 | 2.8 | 2.7 | 2.6 |
| Thermal foaming | — | — | — | — | — | 4.6 | — | — | — |
| agent 1 | | | | | | | | | |
| Thermal foaming | 8.0 | 8.0 | 8.0 | 6.3 | 6.4 | — | 5.5 | 8.0 | 10.4 |
| agent 2 | | | | | | | | | |
| Heating condition | 180° C. × 30 min | | | | | | 150° C. × 30 min | | |
| Foaming | — | — | — | — | — | — | 4.83 | 6.43 | 7.54 |
| magnification | | | | | | | | | |
| [times] | | | | | | | | | |
| Blocking resistance | ∘ | Δ | Δ | ∘ | Δ | x | ∘ | ∘ | ∘ |
| Crack resistane | ∘ | ∘ | ∘ | ∘ | ∘ | ∘ | ∘ | ∘ | ∘ |
| Adhesive strength | ∘ | ∘ | ∘ | Δ | ∘ | x | Δ | ∘ | ∘ |
| [MPa] | (2.40) | (2.45) | (2.41) | (2.15) | (2.43) | (0.88) | (2.38) | (2.61) | (2.59) |
| GAP: 418 μm | | | | | | | | | |
| 23° C. | | | | | | | | | |
| Adhesive strength | — | — | — | — | — | — | ∘ | ∘ | ∘ |
| [MPa] | | | | | | | (2.46) | (3.02) | (2.81) |
| GAP: 351 μm | | | | | | | | | |
| 23° C. | | | | | | | | | |

TABLE 2

| | Ex. 9 | Ex. 10 | Ex. 11 | Ex. 12 | Comp.Ex.2 | Comp.Ex.3 | Comp.Ex.4 |
|---|---|---|---|---|---|---|---|
| Acrylic resin | 11.6 | 12.2 | 16.6 | 23.2 | 24.2 | 17.9 | — |
| Epoxy resin A1 | 4.5 | — | 6.4 | 3.8 | 9.3 | — | 5.1 |
| Epoxy resin A2 | 26.8 | 28.2 | — | 22.8 | 55.8 | — | 30.8 |
| Epoxy resin A3 | — | — | — | — | — | — | — |
| Epoxy resin B1 | 46.4 | 48.9 | 66.3 | 39.5 | — | 71.4 | 53.4 |
| Epoxy resin B2 | — | — | — | — | — | — | — |
| Epoxy resin C1 | — | — | — | — | — | — | — |
| Curing agent 1 | — | — | — | — | — | — | — |
| Curing agent 2 | 2.7 | 2.7 | 2.7 | 2.7 | 2.7 | 2.7 | 2.7 |
| Thermal foaming | — | — | — | — | — | — | — |
| agent 1 | | | | | | | |
| Thermal foaming | 8.0 | 8.0 | 8.0 | 8.0 | 8.0 | 8.0 | 8.0 |
| agent 2 | | | | | | | |
| Heating condition | 180° C. × 30 min | | | | | | |
| Blocking resistance | ∘ | ∘ | ∘ | ∘ | x | ∘ | ∘ |
| Crack resistane | ∘ | ∘ | ∘ | ∘ | x | ∘ | x |
| Adhesive strength | ∘ | ∘ | ∘ | ∘ | ∘ | x | x |
| [MPa] | (2.95) | (2.74) | (4.75) | (2.72) | (3.00) | (2.05) | (1.48) |
| GAP: 351 μm | | | | | | | |
| 23° C. | | | | | | | |
| Adhesive strength | ∘ | ∘ | — | ∘ | ∘ | x | x |
| [MPa] | (0.43) | (0.30) | | (0.30) | (0.36) | (0.13) | (0.26) |
| GAP: 351 μm | | | | | | | |
| 200° C. | | | | | | | |

TABLE 3

| | |
|---|---|
| Acrylic resin | PMMA-PBuA-PMMA (partially acrylamide group) |
| | Tg: -20° C., 120° C., Mw: 150,000 |
| Epoxy resin A1 | Bisphenol A type, solid at room temperature |
| (First epoxy resin) | Softening temperature: 64° C., epoxy equivalent: 450 g/eq, Mw: 900 |
| | melt viscosity at 150° C.: 1.2 Pa•s |
| Epoxy resin A2 | Bisphenol A novolac type, solid at room temperature |
| (First epoxy resin) | Softening temperature: 70° C., epoxy equivalent: 210 g/eq, Mw: 1300 |
| | melt viscosity at 150° C.: 0.5 Pa•s |
| Epoxy resin A3 | Bisphenol A type, solid at room temperature |
| (First epoxy resin) | Softening temperature: 144° C., epoxy equivalent: 2500 g/eq |
| | melt viscosity at 150° C.: 1000 Pa•s, Mw: 5,000 |
| Epoxy resin A4 | Bisphenol F type, solid at room temperature |
| (First epoxy resin) | Softening temperature: 77° C., epoxy equivalent: 184-200 g/eq |
| | melt viscosity at 150° C.: 0.008 Pa•s |
| Epoxy resin A5 | Hydroquinone type, solid at room temperature |
| (First epoxy resin) | Softening temperature: 138° C., epoxy equivalent: 170-180 g/eq |
| | melt viscosity at 150° C.: 0.014 Pa•s |
| Epoxy resin B1 | BPA phnoxy type, solid at room temperature |
| (Second epoxy resin) | Softening temperature: 110° C., epoxy equivalent: 8000 g/eq, Mw: 50,000 |
| Epoxy resin B2 | BPA phnoxy type, solid at room temperature |
| (Second epoxy resin) | Softening temperature: 150° C., Mw: 38,000 |
| Epoxy resin C1 | Bisphenol A type, in liquid form |
| (low molecular weight) | viscosity: 120-150 cps (25° C.), epoxy equivalent: 190 g/eq |
| Phenol resin | Biphenyl aralkyl novolac type modified phenol |
| | Softening temperature: 99° C., OH equivalent: 132 g/eq |
| | melt viscosity at 150° C.: 0.5 Pa•s |
| Curing agent 1 | Resol type phenol resin |
| Curing agent 2 | 2-Phenylimidazole-4,5-diyldimethanol |
| | average particle size: 3 μm, melting point: 230° C., |
| | reaction start temperature: 145° C.-155° C., active region: 155° C.-173° C. |
| Thermal foaming agent 1 | Azodicarbonamide |
| Thermal foaming agent 2 | Thermal expansion microcapsule |
| | average particle size: 14-20 μm |
| | expansion start temperature: 120° C.-130° C., |
| | maximum expansion temperature: 160° C.-170° C. |
| | core: hydrocarbon, shell: acrylonitrile copolymer |

As shown in Table 1 and Table 2, in Examples 1 to 12, all of the blocking resistance, the adhesiveness and the crack resistance were confirmed to be good. Meanwhile, in Comparative Example 1, since an epoxy resin having a low molecular weight was used, blocking easily occurred. Also, in Comparative Examples 2 to 4, since either of the acrylic resin, the first epoxy resin, and the second epoxy resin was not included, not all of the blocking resistance, the adhesiveness, and the crack resistance were achieved.

### Reference Example

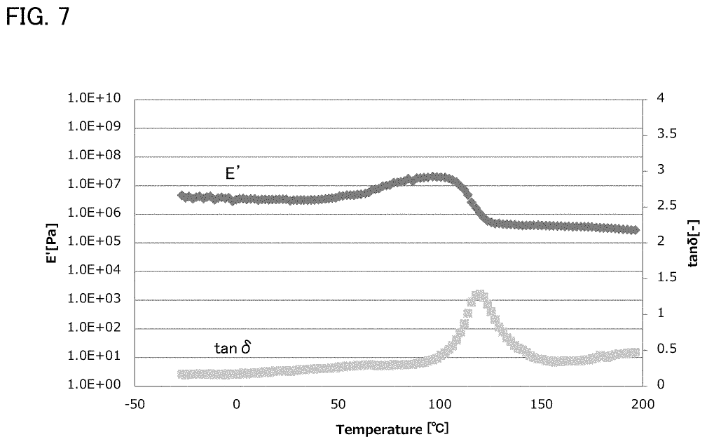

Dynamic viscoelasticity measurement of the acrylic resin alone used in Example 1 was carried out. First, the acrylic resin was dissolved into ethyl acetate so as to have a solid content of 30 mass %. Next, it was applied onto a PET separator (PET50×1J2 manufactured by Nippa Co., Ltd.) using an applicator so as to have a thickness of 50 μm, and dried in a drying oven at 100° C. for 3 minutes to form a polymer layer. The storage elastic modulus (E′) and loss tangent (tan 5) of the polymer layer peeled off from the separator were measured using a solid viscoelastic analyzer (RSA-III manufactured by TA Instruments Co., Ltd.), by a dynamic viscoelastic measuring method according to JIS K 7244-1 (attachment mode: compression mode, frequency: 1 Hz, temperature: −30° C. to 200° C., temperature rising rate: 10° C./min). The results are shown in FIG. 7.

As shown in FIG. 7, the acrylic resin used in Example 1 had a storage elastic modulus (E′) of 1×10⁶ Pa or less at, for example, at the foaming start temperature (120° C.) of the thermal foaming agent 2. Therefore, at the start of foaming, fluidity was improved, and it was able to obtain good foaming property. Also, the acrylic resins used in Example 1 had a storage elastic modulus (E′) of 1×10⁵ Pa or more at the curing start temperature (145° C.) of the curing agent 2, for example. As described above, since a shrinkage may occur during curing after foaming (the term from the completion of foaming of the foaming agent until the adhesive composition is cured), it is preferable that the adhesive composition has a certain degree of viscoelasticity on this occasion. For example, the first epoxy resin will be in a condition that is almost a liquid at a temperature of the softening temperature or more. Meanwhile, since the acrylic resin used in Example 1 had E′ of, for example, 1×10⁵ Pa or more even at the curing start temperature of the curing agent 2 (145° C.), the shrinkage may be suppressed and good shape retainability may be obtained. Also, since the average value of the storage elastic modulus (E′) of the acrylic resin used in Example 1 at 0° C. or more and 100° C. or less was 1×10⁶ Pa or more, it was possible to obtain good blocking resistance.

### Example 13

An adhesive composition having a composition (mass %) shown in Table 4 below was prepared. Incidentally, although not described in Table 4, the adhesive composition included ethyl acetate as a solvent, and all of them were adjusted so as to have a solid concentration of 35 mass %. Also, details of each material described in Table 4 are shown in Table 3.

Next, as a substrate, a polyphenylene sulfide film (PPS film, thickness: 100 μm) having a high insulating property was prepared, and stress releasing layers were formed on both surfaces. Specifically, with respect to 100 mass parts of the polyester/vinyl chloride vinyl acetate copolymer, a curing agent (polyisocyanate) was prepared at the proportion of 2 mass parts, further diluted with methyl ethyl ketone (MEK) so that the solid content was 15%, applied onto the substrate by a bar coater, and dried in a thermal oven for 3 minutes at 120° C. In this way, a stress releasing layer having a thickness of 2 μm was formed on both sides of the substrate (first stress releasing layer and the second stress releasing layer). Thereafter, an adhesive layer (first adhesive layer and second adhesive layer) was formed on the obtained stress releasing layer in the same manner as in Example 1. Thus, a foaming adhesive sheet comprising the first adhesive layer, the first stress releasing layer, the substrate, the second stress releasing layer, and the second adhesive layer placed in this order was obtained. The obtained foaming adhesive sheet was evaluated for blocking resistance, crack resistance and adhesiveness in the same manner as in Example 1. The results are shown in Table 4.

TABLE 4

| | Ex. 13 |
|---|---|
| Acrylic resin | 11.5 |
| Epoxy resin A1 | — |
| Epoxy resin A2 | 35.3 |
| Epoxy resin A3 | — |
| Epoxy resin B1 | 37.1 |
| Epoxy resin B2 | — |
| Epoxy resin C1 | — |
| Phenol resin | 5.3 |
| Curing agent 1 | — |
| Curing agent 2 | 2.7 |
| Thermal foaming agent 1 | — |
| Thermal foaming agent 2 | 8.1 |
| Heating condition | 180° C. × 30 min |
| Foaming magnification | 9.6 |
| [times] | |
| Blocking resistance | ∘ |
| Crack resistane | ∘ |
| Adhesive strength [MPa] | ∘ |
| GAP: 351 μm | (5.30) |
| 23° C. | |
| Adhesive strength [MPa] | ∘ |
| GAP: 351 μm | (0.65) |
| 200° C. | |

As shown in Table 4, in Example 13, it was confirmed that all of the blocking resistance, the adhesiveness and the crack resistance were good. In Example 13, although the heat resistance was improved since the phenol resin was included, there was a concern that the crack resistance was lowered, on the other hand. However, it was confirmed that by providing the stress releasing layer, both of the improvement of the heat resistance, and the suppression of deterioration of crack resistance may be achieved.

### Examples 14 and 15

An adhesive composition having a composition (mass %) shown in Table 5 below was prepared. Incidentally, although not described in Table 5, the adhesive composition included ethyl acetate as a solvent, and all of them were adjusted so as to have a solid concentration of 35 mass %. Also, details of each material described in Table 5 are shown in Table 3.

Next, a polyphenylene sulfide film (PPS film, thickness: 100 μm) having high insulating property was prepared as a substrate, and the adhesive composition was applied to one surface of this substrate using an applicator so that a thickness after coating was 45 μm. Thereafter, it was dried for 3 minutes at 100° C. in a drying oven to form an adhesive layer. An adhesive layer was similarly formed on the other surface of the substrate to obtain a foaming adhesive sheet wherein the adhesive layer was formed on the front and back of the substrate, respectively.

TABLE 5

| | Ex. 14 | Ex. 15 |
|---|---|---|
| Acrylic resin | 11.5 | 11.5 |
| Epoxy resin A1 | — | — |
| Epoxy resin A2 | 17.6 | 17.6 |
| Epoxy resin A3 | — | — |
| Epoxy resin A4 | 17.7 | — |
| Epoxy resin A5 | — | 17.7 |
| Epoxy resin B1 | 37.1 | 37.1 |
| Epoxy resin B2 | — | — |
| Epoxy resin Cl | — | — |
| Phenol resin | 5.3 | 5.3 |
| Curing agent 1 | — | — |
| Curing agent 2 | 2.7 | 2.7 |
| Thermal foaming agent 1 | — | — |
| Thermal foaming agent 2 | 8.1 | 8.1 |
| Heating condition | 180° C. × 30 min | |
| Foaming magnification | 9.4 | 9.1 |
| υtimes] | | |
| Blocking resistance | Δ | Δ |
| Crack resistane | ∘ | ∘ |
| Adhesive strength [MPa] | ∘ | ∘ |
| GAP: 351 μm | (2.9) | (2.6) |
| 23° C. | | |
| Adhesive strength [MPa] | ∘ | ∘ |
| GAP: 351 μm | (0.35) | (0.31) |
| 200° C. | | |

As shown in Table 5, in Examples 14 and 15, it was confirmed that all of the blocking resistance, the adhesiveness and the cracking resistance were good. Meanwhile, in Examples 14 and 15, it was confirmed that the blocking resistance was slightly low. It is presumed that this is because the pressure-sensitive adhesiveness (tack property) of the obtained adhesive layer was increased due to the high crystallinity (low melt viscosity) of the first epoxy resin used in Examples 14 and 15. Therefore, it was suggested that the crystallinity of the first epoxy resin is preferably not too high.

### REFERENCE SIGNS LIST

1: adhesive layer

2: substrate

10: foaming adhesive sheet

11: adhesive sheet after foamed and cured

2: member

100: product

1-15. (canceled)

16. An adhesive composition comprising an epoxy resin, an acrylic resin compatibilized with the epoxy resin, a curing agent, and a foaming agent,
wherein, as the epoxy resin, the adhesive composition includes a first epoxy resin with a softening temperature of 50° C. or more and an epoxy equivalent of 5000 g/eq or less, and a second epoxy resin with a softening temperature higher than the first epoxy resin and a weight-average molecular weight of 20,000 or more, and
a weight-average molecular weight of the acrylic resin is 50,000 or more.

17. The adhesive composition according to claim 16, wherein a weight-average molecular weight of the first epoxy resin is 6,000 or less.

18. The adhesive composition according to claim 16, wherein, when a resin component included in the adhesive composition is regarded as 100 mass parts, a content of the first epoxy resin is 3 mass parts or more and 80 mass parts or less.

19. The adhesive composition according to claim 16, wherein, when a resin component included in the adhesive composition is regarded as 100 mass parts, a content of the second epoxy resin is 15 mass parts or more and 85 mass parts or less.

20. The adhesive composition according to claim 16, wherein, when a resin component included in the adhesive composition is regarded as 100 mass parts, a content of the acrylic resin is 3 mass parts or more and 50 mass parts or less.

21. The adhesive composition according to claim 16, wherein, when a resin component included in the adhesive composition is regarded as 100 mass parts,
the content of the first epoxy resin is 3 mass parts or more and 80 mass parts or less,
the content of the second epoxy resin is 15 mass parts or more and 85 mass parts or less, and
the content of the acrylic resin is 3 mass parts or more and 50 mass parts or less.

22. The adhesive composition according to claim 16, wherein a melt viscosity of the first epoxy resin at 150° C. is 0.03 Pa·s or more and 10 Pa·s or less.

23. The adhesive composition according to claim 16, wherein the first epoxy resin is a bisphenol A novolac type epoxy resin.

24. The adhesive composition according to claim 16, wherein a storage elastic modulus (E′) of the acrylic resin is 1×10⁶ Pa or less at a foaming start temperature, and 1×10⁵ Pa or more at a curing start temperature.

25. The adhesive composition according to claim 16, wherein the adhesive composition is used for an adhesive layer of a foaming adhesive sheet.

26. A foaming adhesive sheet comprising at least an adhesive layer,
wherein the adhesive layer includes an epoxy resin, an acrylic resin compatibilized with the epoxy resin, a curing agent, and a foaming agent,
as the epoxy resin, the adhesive layer includes a first epoxy resin with a softening temperature of 50° C. or more and an epoxy equivalent of 5000 g/eq or less, and a second epoxy resin with a softening temperature higher than the first epoxy resin and a weight-average molecular weight of 20,000 or more, and
a weight-average molecular weight of the acrylic resin is 50,000 or more.

27. The foaming adhesive sheet according to claim 26, wherein, as the adhesive layer, the foaming adhesive sheet includes a first adhesive layer and a second adhesive layer, and
the first adhesive layer, a substrate, and the second adhesive layer are placed in this order in a thickness direction.

28. The foaming adhesive sheet according to claim 27, wherein a first stress releasing layer is placed between the first adhesive layer and the substrate.

29. The foaming adhesive sheet according to claim 28, wherein a second stress releasing layer is placed between the substrate and the second adhesive layer.

30. The foaming adhesive sheet according to claim 28, wherein at least one of the first adhesive layer and the second adhesive layer includes a phenol resin.
